(19) United States
(12) Patent Application Publication
(10) Pub. No.: US 2002/0134193 A1
(43) Pub. Date: Sep. 26, 2002

(54) Cylinder block extension frame

(76) Inventor: Howard J. Lawrence, Shirley (GB)

Correspondence Address: CATERPILLAR INC., 100 N.E. ADAMS STREET, PATENT DEPT., PEORIA, IL, 616296490

(21) Appl. No.: 10/097,721

(22) Filed: Mar. 14, 2002

(30) Foreign Application Priority Data
Mar. 20, 2001 (GB) 0106859.2

(51) Int. Cl. F16H 57/02

(52) U.S. Cl. 74/606 R

(57) ABSTRACT

An engine and transmission unit assembly has an extension frame fixedly connected to a cylinder block and cylinder head of the engine and the transmission unit, which is itself attached to the cylinder block. The extension frame, which may include an apron connected to a surface of the cylinder block, increases the natural frequency of vibration of the engine and transmission unit assembly, thereby reducing noise.

### TECHNICAL FIELD

This invention relates to an engine and transmission unit assembly having reduced noise and vibration. The invention also relates to a method of reducing noise and vibration from an engine and transmission unit assembly.

### BACKGROUND

Internal combustion engines are a source of noise and vibration which may be undesirable. The noise and vibration results from the vibration frequencies created by the combustion events in an engine. It is desirable for the bending (beaming) frequency of an engine and transmission unit assembly to be outside of the firing frequency of the engine so that the firing frequency does not excite the bending mode.

250 Hz is generally regarded as a critical frequency below which undesirable noise and vibration may occur.

Japanese Patent Application No 2185655 describes a bracket which functions to rigidly connect an engine transmission unit with a cylinder block of an engine. Use of the bracket improves the rigidity of an engine assembly and increases the natural frequency of vibration of the engine assembly.

The present invention sets out to raise the bending frequency of an engine and transmission unit assembly to obviate or mitigate any undesirable noise and vibration therefrom.

### SUMMARY OF THE INVENTION

In accordance with one aspect of this invention, and engine and transmission unit assembly comprises an engine including a cylinder block and a cylinder head, a transmission unit attached to the cylinder block, and an extension frame connected to the cylinder block, the cylinder head, and the transmission unit. The extension frame increases the natural frequency of vibration of the engine and transmission unit assembly.

In accordance with another aspect of this invention, a method of reducing transmitted noise and vibration from an engine including a cylinder block, a cylinder head, and a transmission unit. The method comprises the steps of providing an extension frame, and connecting the extension frame to the cylinder block, the cylinder head, and the transmission unit to increase the natural frequency of vibration of the engine and transmission unit assembly.

In accordance with yet another aspect of this invention, a method of manufacturing an engine and transmission unit assembly comprises providing an engine including a cylinder block and a cylinder head, providing a transmission unit, joining the transmission unit with the engine, and attaching an extension frame to the cylinder block, the cylinder head, and the transmission unit. The extension frame increases the natural frequency of vibration of the engine and transmission unit assembly.

### BRIEF DESCRIPTION OF THE DRAWINGS

Various embodiments of the invention will now be described, by way of example only, having regard to the accompanying diagrammatic drawings in which:

FIG. 1 is an isometric view of an engine and transmission unit assembly in which the cylinder block of the engine is fitted with an apron (shown partly cut away), the apron including an extension frame in accordance with the invention; and

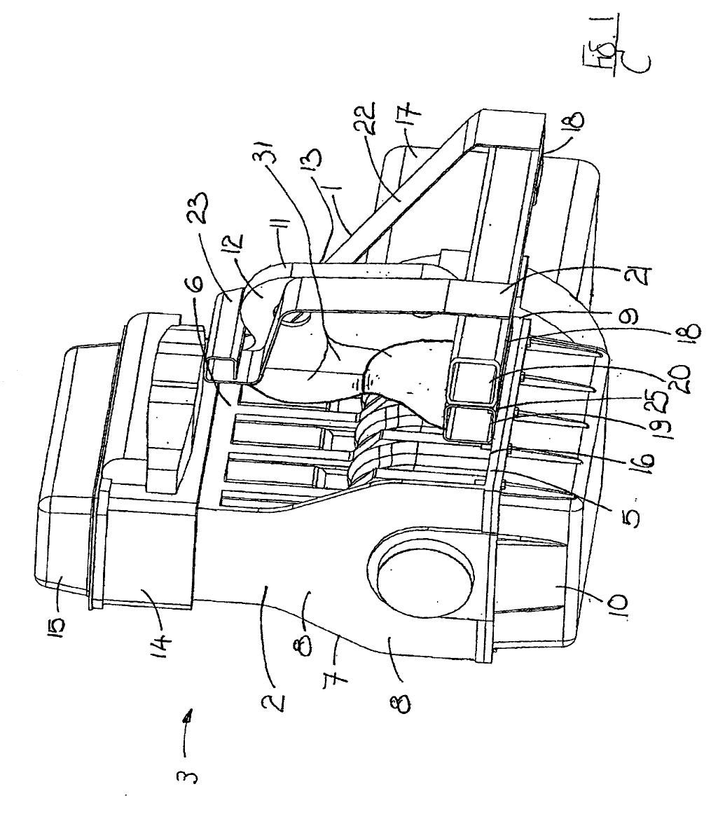

FIG. 2 is a side view of the engine, transmission unit and apron and extension frame of FIG. 1.

### DETAILED DESCRIPTION

As shown in the drawings, an engine and transmission unit assembly in accordance with the invention is made up of an extension frame 1 extending between a cylinder block 2, a cylinder head 14 and a transmission unit 17. The extension frame 1 increases the specific stiffness of the assembly of engine 3 and transmission unit 17 thereby increasing the natural bending/torsion frequency of the engine and transmission unit assembly to reduce noise and vibration therefrom. In a preferred embodiment the extension frame 1 includes an apron 31 mounted to a first side wall 6 of a cylinder block 2 of the engine 3. The apron 31 is a tray-like panel and can extend over part or all of the side wall 6.

In the illustrated embodiment of the invention, the cylinder block 2 is a substantially conventional cylinder block to which an apron 31 may be attached. However, the extension frame 1 may be adapted for use with various cylinder block types without departing from the scope of the invention.

The cylinder block 2 includes a cylinder block base 5, the cylinder block first side wall 6, a cylinder block second side wall 7 substantially parallel with the cylinder block first side wall 6, a cylinder block front end wall 8 and a cylinder block rear end wall (not shown), all upstanding from the cylinder block base 5.

The cylinder block rear end wall is provided with a bearing plate 11 which projects laterally outwards from the first side wall 6 to provide for attachment of the transmission unit 17 and other components such as a starter motor or fuel pump (not shown). The bearing plate 11 has an inner face 12 disposed towards the side wall 6 and an outer face 13 disposed away from the side wall 6.

The cylinder block 2 is provided with a cylinder head cover 15 mounted on the cylinder head 14. A sump 10 abuts the cylinder block 2.

The cylinder block 2 has a flange 16 at the cylinder block base 5 along the first and second side walls 6, 7. The flange 16 is provided with flange holes 25 for attaching the apron 31 to the cylinder block 2 as shall be explained more fully below. The flange holes 25 also serve to receive fasteners 26 for securing the sump 10 to the cylinder block base 5. The fasteners 26 may be any suitable fasteners.

The extension frame 1 is substantially rigid in construction and, as indicated above, extends between the cylinder block 2, the cylinder head 14 and the transmission unit 17. Preferably, the extension frame includes an integral apron 31 and a generally triangulated portion including frame members 18, 21, 22 arranged to brace from spaced apart points 32, 33 on the apron 31 to a point 34 at, or substantially towards, a spaced apart end 35 of the transmission unit 17.

In the illustrated example the extension frame 1, which includes the apron 31 as an integral part thereof, is additionally made up of a number of frame members, including a transverse double box-like beam 18 having a truncated inner box-like beam 19 and an outer box-like beam 20, an upright strut 21 extending between the transverse double box-like beam 18 and an extension frame top rail 23, and a diagonal strut 22 extending between the top rail 23 and the transverse double box-like beam 18.

The frame members, including the inner box like beam 19, the outer box-like beam 20, the upright strut 21, the diagonal strut 22 and the top rail 23, are preferably formed from a sheet-metal, but may be formed from any other suitable material. The parts making up the extension frame 1 may be formed integrally with the apron 31, as top rail 23 in the illustrated example, or suitably attached to the apron 31 by welding or other means, as outer box-like beam 20 in the illustrated example. It is envisaged that at least some of the parts making up the extension frame 1 will need to be fabricated separately and subsequently joined to the apron 31 or one to another.

Preferably, the extension frame 1 is mounted between the cylinder block 2, the cylinder head 14 and the transmission unit 17 either side of the bearing plate 11 so that the upright strut 21 is disposed adjacent the bearing plate inner face 12 while the diagonal strut 22 is located externally of the bearing plate outer face 13. The apron 31, the upright strut 21 and the diagonal strut 22 may be secured to the bearing plate 11 for increased integrity of construction if required.

The apron 31 is secured to the cylinder block flange 16 by the fasteners 26 which, as indicated above, simultaneously secure the sump 10 to the cylinder block 2. The first outer box-like beam member 20 extends rearwardly of the cylinder block 2 towards the transmission unit 17. The second inner box-like beam member 19 is truncated between the cylinder block 2 and the transmission unit 17. The purpose of the second inner box-like beam 19 is to stiffen the structure and suitably space the extension frame 1 in relation to the cylinder block side wall 6. It may be found in some installations that the second inner box-like beam 19 is not required. It may also be found that the first outer box-like beam 20, or other constituent parts of the extension frame 1 or apron 31, may provide suitable mounting points for the engine and transmission mountings.

In use, the apron 31 of the extension frame 1 is attached to the cylinder block 2 with fasteners 26 as previously described to lower attachment points. The extension frame 1 is also attached to the cylinder head 14 at upper attachment points at or close to the top rail 23 by fasteners 24. The apron 31 may also be adhesively attached or otherwise conventionally fastened at other points on the cylinder block or the cylinder head as may be desired for improved integrity of construction.

The extension frame 1 extends rearwardly of the cylinder block 2 and in the present embodiment is secured to the transmission unit 17 at the double box-like beam 18 disposed adjacent the diagonal strut 22.

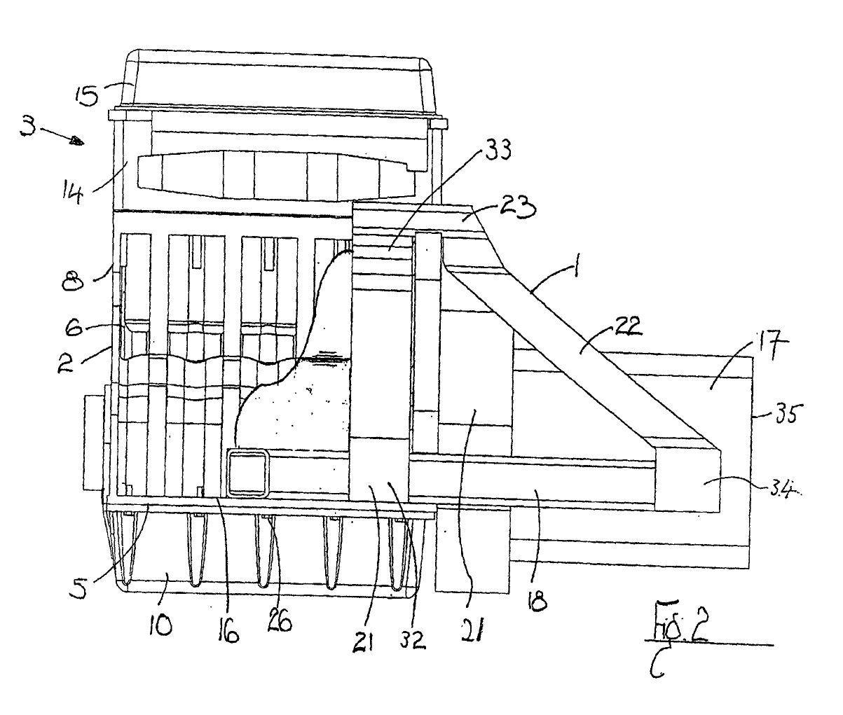

In an alternative embodiment of the invention, not illustrated, the extension frame 1 can be employed independently of an apron 31 applied to the cylinder block side wall 6, 7 or in the absence of an apron. In such an embodiment, the extension frame 1 may be made up as a generally triangulated frame of frame members for direct attachment to the engine 3 at spaced apart attachment points on the cylinder block 2 and the cylinder head 14 (which points would generally correspond to upper and lower points 33, 32 respectively on the apron 31 of FIG. 2) to a point 34 at, or substantially towards, a spaced apart end 35 of the transmission unit 17.

### INDUSTRIAL APPLICABILITY

The extension frame 1 of the present invention serves to increase the natural bending/torsion frequency of an engine to reduce transmitted noise and vibration. For example, in a conventional engine, the critical bending/torsion frequency giving rise to transmitted noise is considered to be approximately 250 Hz while a typical conventional cylinder block gives rise to a frequency of approximately 300 Hz. A transmission unit 17 in a typical conventional engine reduces the overall frequency by approximately 80 Hz to below the critical frequency of 250 Hz thereby giving rise to significant transmitted noise and vibration. However, where the extension frame 1 of the invention is disposed between the cylinder block 2, the cylinder head 14 and the transmission unit 17, the frequency is increased to above the critical frequency of 250 Hz to increase the natural bending/torsion frequency and to thereby reduce noise and vibration therefrom.

The extension frame 1 therefore forms a bridge between the cylinder block 2, the cylinder head 14 and the transmission unit 17. The Applicants have found that the natural frequency of vibration of the engine and transmission unit assembly is increased by the fixed connection of the extension frame 1 to the cylinder block 2, the cylinder head 14 and the transmission unit 17. The extension frame 1 increases the second moment of area between the cylinder block 2, cylinder head 14 and the transmission unit 17 to increase the specific stiffness of the engine and transmission unit assembly to give rise to the increased natural bending/torsion frequency.

It will be appreciated by those skilled in the art that the extension frame 1 of the invention can be modified in accordance with particular engine requirements and the tuning requirements thereof to increase the natural bending/torsion frequency by a desired amount

In the given example, the parts making up apron 31 are envisaged as having a thickness of from about 2 to about 4 millimeters but thickness selection will need to take into account variables such as the required stiffness, ease of forming and the duty to which the apron 31 and the extension frame 1 are to be subjected to, taking into account the accessories to be mounted thereon and whether engine mountings and transmission housings are to be attached thereto. The apron 31 and extension frame 1 may be reinforced locally as required. The apron 31 may be flat folded and bent or pressed to shape as required.

The apron 31 and the extension frame 1 are preferably formed from high strength low alloy (HSLA) steel but can also be formed from cold rolled mild steel, aluminum sheet or any other material having suitable characteristics. The apron 31 and the extension frame 1 can be configured by laser machining or the like or may be numerically controlled punch profiled. The apron 31 may be folded by a brake press and deep drawn for pressed features.

The extension frame 1 can be formed by welding or otherwise joining one or more parts to form a single integral apron 31 and extension frame 1. Alternatively, as already indicated, the extension frame 1 may be fitted to the cylinder block independently of any apron. Further, the apron or its constituent parts may be configured as tailored blanks comprising panel parts of different thickness or different metallurgy. For example, the apron 31 could be formed in general from a mild steel whilst the extension frame 1 could be formed in part or as a whole from an alloy steel.

The extension frame 1 of the invention finds application in engine and transmission unit assemblies where it is desired to reduce noise and vibration therefrom. The extension frame of the invention also finds application in automotive engine and transmission unit assemblies where reductions in noise and vibration therefrom are particularly sought after.

The invention is not limited to the embodiments herein described, which may be varied in construction and detail.

What is claimed is:

1. An engine and transmission unit assembly comprising:
an engine including a cylinder block and a cylinder head;
a transmission unit attached to the cylinder block; and
an extension frame fixedly connected to the cylinder block, the cylinder head, and the transmission unit, wherein the extension frame increases the natural frequency of vibration of the engine and transmission unit assembly.

2. An engine and transmission unit assembly as set forth in claim 1 wherein the extension frame includes a plurality of frame members connected to form a triangulated frame.

3. An engine and transmission unit assembly as set forth in claim 1 wherein the cylinder block has a surface provided with apron attachment points, and the extension frame includes an apron mounted on said surface.

4. An engine and transmission unit assembly as set forth in claim 2 wherein the cylinder block has a surface provided with apron attachment points, and the extension frame includes an apron mounted on said surface.

5. An engine and transmission unit assembly as set forth in claim 1 wherein the extension frame includes a plurality of frame members extending between the apron and the transmission unit.

6. An engine and transmission unit assembly as set forth in claim 1 wherein the extension frame includes a first beam member extending between the cylinder block and the transmission unit.

7. An engine and transmission unit assembly as set forth in claim 6 wherein the extension frame further includes a second beam member adjacent to the first beam member and serving to space the first beam member from the cylinder block.

8. A method of reducing transmitted noise and vibration from an engine including a cylinder block, a cylinder head and a transmission unit attached to the cylinder block, comprising the steps of providing an extension frame, and fixedly connecting the extension frame to the cylinder block, the cylinder head and the transmission unit to increase the natural frequency of vibration of the engine and transmission unit assembly.

9. A method as set forth in claim 8 wherein the extension frame includes an apron, including the steps of providing apron attachment points on a surface of the cylinder block, and mounting the apron on said surface.

10. A method of manufacturing an engine and transmission unit assembly, comprising:
providing an engine including a cylinder block and a cylinder head;
providing a transmission unit;
joining said transmission unit with said engine; and
attaching an extension frame to said cylinder block, said cylinder head, and said transmission unit, said extension frame thereby increasing the natural frequency of vibration of the engine and transmission unit assembly.
